(19) United States
(12) Patent Application Publication
(10) Pub. No.: US 2025/0314622 A1
(43) Pub. Date: Oct. 9, 2025

(54) MONITORED REPAIR SOLUTIONS

(71) Applicant: Team Industrial Services, Inc., Sugar Land, TX (US)

(72) Inventors: Urban WEINHEIMER, Sugar Land, TX (US); Peter SHWETS, Sugar Land, TX (US); Paul HILL, Sugarland, TX (US)

(21) Appl. No.: 18/865,234

(22) PCT Filed: May 12, 2023
(86) PCT No.: PCT/US2023/021989

§ 371 Date: Nov. 12, 2024

Related U.S. Application Data
(60) Provisional application No. 63/341,480, filed on May 13, 2022.

(51) Int. Cl. G01N 29/04; G01B 17/02; G01N 29/24

(52) U.S. Cl. CPC G01N 29/043; G01B 17/02; G01N 29/2437; G01N 2291/0231

(57) ABSTRACT

Systems and method for monitoring assets. The system may include one or more sensors coupled to the asset. The sensors may include an ultrasonic transmitter configured to transmit one or more signals in the form of ultra-sonic pulses to the asset, an ultrasonic receiver configured to receive the signals, a signal processing module configured to process measurements taken by the signals, and a communication module configured to store data regarding measurements taken by the signals and transmit the data to an analysis module. The method may include receiving information regarding the condition of the asset based on the data.

### FIELD OF DISCLOSURE

In general, the disclosure describes monitoring methods and systems for mechanical fluid containment assets. More specifically, the disclosure describes monitoring methods and systems for monitoring repairs performed on fluid containment assets.

### BACKGROUND OF DISCLOSURE

Mechanical fluid containment assets in oil, gas, and chemical industries need to be inspected and periodically repaired to ensure the integrity of the assets. These assets may include atmospheric tanks, pressure vessels, fired heaters, pipes, and valves. The assets each may corrode at different rates, and corrosion may reduce the operational life of the assets. The corrosion rate of the assets is determined and tracked by scheduling multiple inspections over the life of the assets. Inspections are used to provide a data set of information to determine the condition of each asset, including corrosion rates and physical measurements of the asset.

Asset conditions may be used to determine the frequency of inspections and recommended repair work to maintain the assets. For example, defects in the structural integrity of the asset may require repairs with the use of composite materials, such as fiber reinforced composite materials. Similarly, the repair work may comprise the use of mechanical devices such as clamps to cure the defects in the asset. The condition of repairs (i.e. composite repairs, clamps, etc.) continuously change over time, due to corrosion and other factors.

What is needed is an improved method for monitoring the conditions of repairs and repaired assets.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

In one embodiment, a system for monitoring assets comprises an asset; and one or more sensors coupled to the asset, wherein the sensors comprise: an ultrasonic transmitter configured to transmit one or more signals in the form of ultra-sonic pulses to the asset; an ultrasonic receiver configured to receive the signals; a signal processing module configured to process measurements taken by the signals; and a communication module configured to store data regarding measurements taken by the signals and transmit the data to an analysis module, wherein the analysis module is a component of the sensors or is a component of a cloud based system, and wherein the analysis module is configured to analyze the data and determine a condition of the asset based on the data.

In one embodiment, a method for monitoring assets comprises coupling one or more sensors to an asset, wherein the sensors comprise: an ultrasonic transmitter configured to transmit one or more signals in the form of ultra-sonic pulses to the asset; an ultrasonic receiver configured to receive the signals; a signal processing module configured to process measurements taken by the signals; and a communication module configured to store data regarding measurements taken by the signals and transmit the data to an analysis module, wherein the analysis module is a component of the sensors or is a component of a cloud based system, and wherein the analysis module is configured to analyze the data and determine a condition of the asset based on the data; and receiving information regarding the condition of the asset based on the data.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is an illustration of a repair using a composite wrap to cure a defect in the integrity of a pipe, according to one embodiment.

FIG. 2A is an illustration of a clamp that can be used to cure a defect in the integrity of a pipe, according to one embodiment.

FIG. 2B is an illustration of a repair using the clamp to cure a defect in the integrity of the pipe, according to one embodiment.

FIG. 3A is an example sensor array on a pipe that can be used in embodiments of the present disclosure.

FIG. 3B is a side view of the example sensor array on the pipe that can be used in embodiments of the present disclosure.

FIG. 3C is an illustration of a controller in communication with a sensor of the example sensor array that can be used in embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

Monitoring methods and systems of asset repairs are described in the present disclosure. The assets may be any structural body that retains a product, which could be gas, liquid, or a mixed phase media of solids, liquids, and/or gases. For example, the assets may include atmospheric tanks, pressure vessels, fired heaters, pipes, and valves. The assets being maintained may be components of a plant or system industries such as the oil, gas, or chemical industries. As repair work is conducted during the lifetime of the assets, the present disclosure describes methods and system to continuously monitor the state of the repair work and the repaired asset.

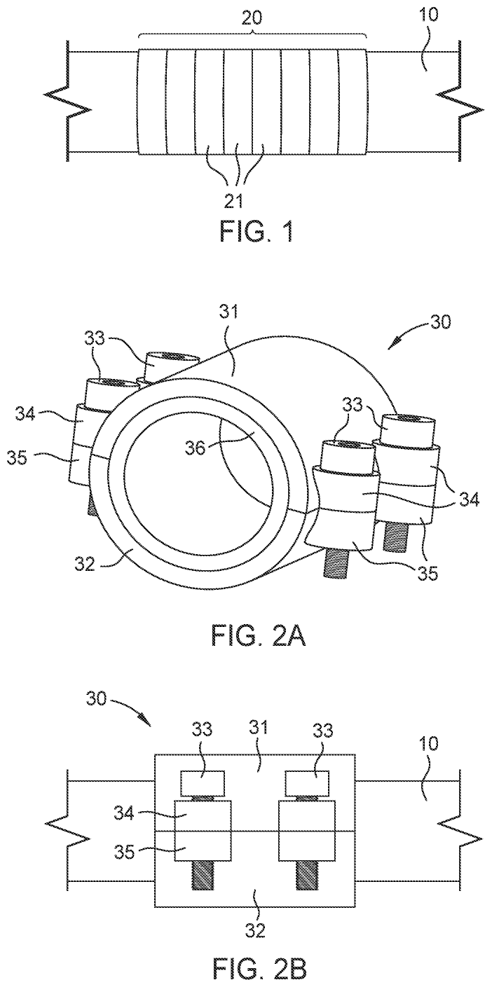

FIG. 1 illustrates the use of composite materials to perform a repair on a structural body, illustrated according to one example as a pipe 10. It should be understood that this is just one example repair and the present disclosure is not so limited. Specifically, FIG. 1 illustrates a composite wrap 20 that is wrapped around a defect in the pipe 10. The composite wrap 20 may be a fiber reinforced composite wrap. One or more composite layers 21 of the composite wrap 20 are wrapped around the outer surface of the pipe 10 to ensure that the integrity of the pipe 10 is maintained. The one or more composite layers 21 can also be wrapped on top of other composite layers 21 such that there are two, three, four, five, or more composite layers 21 of thickness of the composite wrap 20 disposed on the outer surface of the pipe 10. The composite wrap 20 can also be placed along any axial length of the pipe 10 needed to repair the defect. According to one example, the defect in the pipe 10 may be a portion of the pipe 10 that has a wall thickness below a specified minimum wall thickness. The integrity of the pipe 10 is compromised or may be compromised should any portion of the wall thickness of the pipe 10 fall below the minimum specified wall thickness. The defect may also be a hole, dent, crack, opening, or other type of flaw in the pipe 10 such that the integrity of the pipe 10 is compromised or potentially compromised. For example, the integrity of the pipe 10 may be compromised if the pipe 10 bursts, leaks, or otherwise cannot maintain a specified minimum fluid pressure as pressurized fluid is pumped through the pipe 10.

FIG. 2A is an illustration of a clamp 30 that can be used to cure a defect in the integrity of a pipe 10, according to one embodiment. FIG. 2B is an illustration of a repair using the clamp 30 to cure a defect in the integrity of the pipe 10, according to one embodiment. It should be understood that these are just example repairs and the present disclosure is not so limited.

Referring to FIGS. 2A and 2B, the clamp 30 comprises an upper body 31 that is coupled to a lower body 32 by one or more connectors 33, which may be screws. The upper body 31 and the lower body 32 may generally be in the form of a half cylinder such that when coupled together the upper body 31 and lower body 32 form a cylindrical shape. The upper body 31 includes one or more connection support members 34 disposed along opposite edges of the upper body 31. The lower body 32 similarly includes one or more connection support members 35 disposed along opposite edges of the lower body 32. The connection support members 34, 35 may be integrally formed with the upper and lower bodies 31, 32, such as protrusions that extend radially outward from the upper and lower bodies 31, 32. The connection support members 34 of the upper body 31 align with the connection support members 35 of the lower body 32 when the upper and lower bodies 31, 32 are placed adjacent to each other. The one or more connectors 33 may be threaded into threaded bores formed through the connection support members 34, 35 to couple the upper body 31 to the lower body 32. A sealing element 36 may be disposed along the inner surfaces of the upper and lower bodies 31, 32. The sealing element 36 forms a seal against the outer surface of the pipe 10 when the upper and lower bodies 31, 32 are coupled together. The sealing element 36 may be, but is not limited to, an elastomeric material or a metallic material. The clamp 30 itself can be any axial length and can be placed along any axial length of the pipe 10 needed to repair the defect.

Embodiments of the present disclosure includes various inspection systems, such as the ultrasonic Eagle Array™ system offered by Berkeley Springs Instruments. The Eagle Array™ provides an internal corrosion assessment of the mechanical integrity of pipes, pipelines, towers, and tanks. These types of inspection systems have extremely low power requirements (e.g. as little as 5 volts of electrical force) which allows the inspection system to be operated remotely for extended periods of time, thus allowing long-term monitoring of repair work through use of auxiliary power means such as batteries. Similarly, the system of UT Comp Inc. described in U.S. Pat. No. 10,816,514 provides analysis of fiber reinforced composites. Both of these example systems may be used to the advantage in the methods and system of the present disclosure.

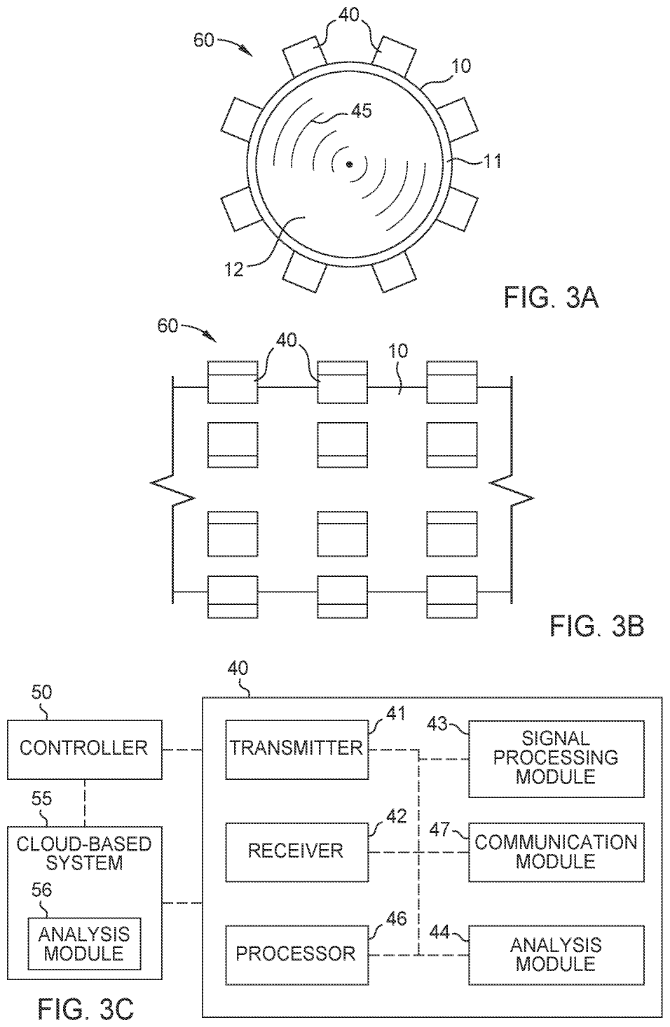

FIG. 3A is a sensor array 60 comprising one or more sensors 40 coupled to a structural body, illustrated according to one example as a pipe 10 that can be used in embodiments of the present disclosure. FIG. 3B is a side view of the sensor array 60 disposed on the pipe 10 that can be used in embodiments of the present disclosure. FIG. 3C is an illustration of a controller 50 and a cloud based system 55 in communication with one of the sensors 40 of the sensor array 60 that can be used in embodiments of the present disclosure.

Referring to FIGS. 3A and 3B, any number of sensors 40 can be disposed on the outer surface of the pipe 10 both radially about the diameter of the pipe 10, as well as axially along the length of the pipe 10. The sensors 40 may be ultrasonic sensors comprising piezoelectric crystals. The sensors 40 can transmit and/or receive one or more signals 45 to measure and/or determine a condition, such as a wall thickness 11, of the pipe 10 at various locations. The signals 45 are transmitted from any one or more of the sensors 40. The signals 45 can be continuously transmitted and/or transmitted at a specified time based intervals. The signals 45 are then reflected back and received by the same sensor 40. The signals 45 are reflected back to the sensor 40 by an object, such as a fluid 12 disposed in an inner bore of the pipe 10. The wall thickness 11 of the pipe 10 can then be determined by the time it takes for the signals 45 to be received back by the sensor 40 that initiated the signal 45. Alternatively or in addition to, since the location of the sensors 40 is known, the sensors 40 can be configured to transmit one or more signals 45 to be received by any one of the other sensors 40 to make the measurements. Based on the wall thickness 11, the integrity of the pipe 10 can be determined. Corrective action, such as further repair of the pipe 10 and/or repair of the prior repair to the pipe 10, can be taken if needed based on the integrity of the pipe 10.

Referring to FIG. 3C, a controller 50 may be configured to transmit and receive information to and from any one of the sensors 40 and/or a cloud based system 55. The information may include, but is not limited to, the location of the sensors 40 relative to the pipe 10, the wall thickness of the pipe 10, the time it took for any signal to be transmitted and received back, the number of signals sent, instructions on when to send signals, etc. The sensors 40 may be ultrasonic sensors having a transmitter 41 (e.g. ultrasonic transmitter) configured to transmit signals, such as ultra-sonic pulses (e.g. sound waves), to the pipe 10. The sensors 40 may include a receiver 42 (e.g. ultrasonic receiver) configured to receive the signals, a signal processing module 43 configured to process the signal measurements, and a communication module 47 configured to store information (e.g. data regarding measurements taken by the signals) and transmit the information to an analysis module 44, which is a component of the sensor 40, and/or transmit the information to an a analysis module 56 which is a component of the cloud based system 55. The communication module 47 may communicate with the controller 50 and/or the cloud based system 55 via wired and/or wireless communication. The cloud based system 55 provides on-demand access, via the internet, to various computing resources such as the analysis module 56. The controller 50 and the cloud based system 55 can similarly communicate with each other via wired and/or wireless communication. The sensor 40 may further include a processor 46 configured to execute instructions or commands from the modules 43, 44, 56, the cloud based system 55, and/or the controller 50. Both modules 44, 56 may be used, or only the analysis module 56 of the cloud based system 55 may be used and the analysis module 44 may not be included as part of the sensors 40. The analysis modules 44, 56 are configured to analyze the signal measurements as further described below.

In one example, the analysis modules 44, 56 are configured to process the signal measurements, calculate a characteristic value (e.g. the wall thickness 11 of the pipe 10) based on the processing of the signal measurements, compare the characteristic value to a baseline established for the characteristic value (e.g. a specified minimum wall thickness of the pipe 10), and determine a percentage of design strength based on the comparison. A variety of outputs can be communicated to the controller 50 to provide information on the condition of the pipe 10. For example, the analysis modules 44, 56 can generate a report comprising details on the locations of the pipe 10 where the signal measurements were taken. For another example, the analysis modules 44, 56 can generate a report comprising how the condition of the pipe 10 has changed during the service life of the pipe 10. Based on the time-rate-of-change, a projection may be generated by the analysis modules 44, 56 of the remaining time until a specific value (e.g. a specific wall thickness 11 of the pipe 10) will be reached. The projection may be based on the type, temperature, and/or pressure of the fluid 11 that is flowing through the pipe 10, as well as a corrosion rate of the material of the pipe 10. In this manner, the controller 50 and/or the cloud based system 55 can be used to continuously monitor the integrity of the pipe 10 based on the signal measurements, calculations, and other information processed and generated by the various components of the sensors 40. The controller 50 and/or the cloud based system 55 can send an alert to an operator when the integrity of the pipe 10 is at risk of being compromised.

In an embodiment of the present disclosure, the sensors 40 illustrated in FIGS. 3A, 3B, and 3C can be used to monitor the integrity of a composite wrap repair, such as the composite wrap 20 illustrated in FIG. 1. In this embodiment, a condition (and other properties) of the asset, which may be a vessel, pipe, valve, heater, and/or tank, will determine and or predict when a composite wrap repair disposed on the asset may no longer be a sufficient repair solution. In another embodiment of the present disclosure, the integrity of the interface between the composite wrap repair and the asset wall (and other properties) can be monitored. The ability to monitor the integrity of the contact between the epoxy of the composite wrap and the surface of the asset is an important indicator regarding the quality of the repair solution.

Another embodiment of the present disclosure monitors the internal integrity of the composite wrap repair (and other properties) itself. In this embodiment, the composite wrap repair is monitored for internal delamination or voids (air gaps) between layers, or in the fiber-resin matrix, that may have resulted from installation or experiences while in service. The signal measurements taken by the sensors 40 will be different in areas of the composite wrap repair where internal delamination or voids between the layers of the composite wrap or in the fiber-resin matrix of the composite wrap occur compared to areas of the composite wrap that do not have any internal delamination or voids.

In yet another embodiment of the present disclosure, the method and system provides a time based measurement of the repair system material properties (and other properties). The measurements would illustrate performance and quality of the repair. This would include the measurement of properties that indicate the current state of the repair system.

Another embodiment of the present disclosure provides a time based measurement of temperature profile through the repair thickness (and other properties). The temperature profile would extend from the repair-asset interface to the outermost point of the repair. The signal measurements taken by the sensors 40 will be different in areas or portions of the repair and/or the asset where the temperature varies.

In an embodiment of the present disclosure, the sensors 40 illustrated in FIGS. 3A, 3B, and 3C can be used to monitor the integrity of mechanical solutions, such as the clamp 30 illustrated in FIGS. 2A and 2B, as well as other strongbacks. In an embodiment, the wall thickness (and other properties) is monitored upstream or downstream of the clamp 30 for purposes of repair and asset compliance. In another embodiment, the method and system is used for monitoring wall thickness (and other properties) in the areas surrounding any mechanical strong-backing solution (axially constraining the clamp/pipe/asset). In yet another embodiment, the method and system is used for monitoring the wall thickness (and other properties) within the repair enclosure for code and mechanical integrity purposes. The signal measurements taken by the sensors 40 can be used to determine the thickness of the pipe 10, the thickness of the sealing element 36, and/or the thickness of the upper and lower bodies 31, 32 of the clamp 30.

In an embodiment of the present disclosure, the method and system comprises one or more sensors (such as sensors 40) to monitor the thickness and respective corrosion rate of a repair clamp (such as the clamp 30 or other mechanical repair device) to predict the remaining life of the repaired asset. Geometry and materials of the repair clamp can be modified to provide a more conservative estimate of the remaining life for the asset that is repaired. For instance, the repair clamp can include a dissimilar material or material identical to the asset. Such material can be monitored for thickness and corrosion rate within the structure of the repair clamp in order to estimate the remaining life of the repaired asset itself.

In yet another embodiment of the present disclosure, the method and system comprises one or more sensors (such as sensors 40) to monitor the thickness of the mechanical repair (such as the clamp 30) to confirm the integrity and remaining life of the mechanical repair, not only the asset. This embodiment enables optimized repairs (e.g. smaller and lighter) to be installed and safely monitored.

The methods and systems of the present disclosure, such as the sensors 40, can additionally measure properties such as dielectric properties, vibration, temperature, humidity, internal clamp pressure, acoustics and chemical detectors (e.g. H2S, Steam, PH, Hydrocarbon, Oxygen, CO2). These properties may be of the asset, a repair to the asset, and/or a fluid in the asset.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

1. A system for monitoring assets, the system comprising:
an asset; and
one or more sensors coupled to the asset, wherein the sensors comprise:
an ultrasonic transmitter configured to transmit one or more signals in the form of ultra-sonic pulses to the asset;
an ultrasonic receiver configured to receive the signals;
a signal processing module configured to process measurements taken by the signals; and
a communication module configured to store data regarding measurements taken by the signals and transmit the data to an analysis module, wherein the analysis module is a component of the sensors or is a component of a cloud based system, and wherein the analysis module is configured to analyze the data and determine a condition of the asset based on the data.

2. The system of claim 1, wherein the asset is a structural body, and wherein the condition is a wall thickness of the structural body.

3. The system of claim 1, wherein the asset is a structural body comprising a repair in the form of a fiber reinforced composite wrap, and wherein the condition is an internal delamination or void between one or more layers of the fiber reinforced composite wrap or in a fiber-resin matrix of the fiber reinforced composite wrap.

4. The system of claim 1, wherein the asset comprises a repair in the form of a mechanical solution, and wherein the condition is a wall thickness of the mechanical solution.

5. The system of claim 4, wherein the mechanical solution is a clamp.

6. The system of claim 1, wherein the sensors are configured to continuously transmit the one or more signals or transmit the one or more signals at time based intervals.

7. The system of claim 1, wherein the analysis module is configured to generate a report comprising details on locations of the asset where the measurements were taken.

8. The system of claim 1, wherein the analysis module is configured to generate a report comprising how the condition of the asset has changed during a service life of the asset.

9. The system of claim 1, wherein the analysis module is configured to generate a projection regarding a remaining time until a specific value regarding the condition of the asset will be reached.

10. The system of claim 9, wherein the projection is based on a type, a temperature, or a pressure of a fluid that is flowing through the asset, as well as a corrosion rate of a material of the asset.

11. A method for monitoring assets, the method comprising:
coupling one or more sensors to an asset, wherein the sensors comprise:
an ultrasonic transmitter configured to transmit one or more signals in the form of ultra-sonic pulses to the asset;
an ultrasonic receiver configured to receive the signals;
a signal processing module configured to process measurements taken by the signals; and
a communication module configured to store data regarding measurements taken by the signals and transmit the data to an analysis module, wherein the analysis module is a component of the sensors or is a component of a cloud based system, and wherein the analysis module is configured to analyze the data and determine a condition of the asset based on the data; and
receiving information regarding the condition of the asset based on the data.

12. The method of claim 11, wherein the asset is a structural body, and wherein the condition is a wall thickness of the structural body.

13. The method of claim 11, wherein the asset is a structural body comprising a repair in the form of a fiber reinforced composite wrap, and wherein the condition is an internal delamination or void between one or more layers of the fiber reinforced composite wrap or in a fiber-resin matrix of the fiber reinforced composite wrap.

14. The method of claim 11, wherein the asset comprises a repair in the form of a mechanical solution, and wherein the condition is a wall thickness of the mechanical solution.

15. The method of claim 14, wherein the mechanical solution is a clamp.
